(19) United States
(12) Patent Application Publication
(10) Pub. No.: US 2024/0281291 A1
(43) Pub. Date: Aug. 22, 2024

(54) Deep Learning Computation with Heterogeneous Accelerators

(71) Applicant: Micron Technology, Inc., Boise, ID (US)

(72) Inventors: Saideep Tiku, Folsom, CA (US); Febin Sunny, Folsom, CA (US); Shashank Bangalore Lakshman, Folsom, CA (US); Poorna Kale, Folsom, CA (US)

(21) Appl. No.: 18/414,842

(22) Filed: Jan. 17, 2024

Related U.S. Application Data
(60) Provisional application No. 63/485,466, filed on Feb. 16, 2023.

(51) Int. Cl. G06F 9/50; G06F 9/48; G06F 15/80

(52) U.S. Cl. CPC G06F 9/5033; G06F 9/4881; G06F 15/80

(57) ABSTRACT

An apparatus having a plurality of accelerators of different types for operations of multiplication and accumulation. In response to a request to perform a task of multiplication and accumulation on input data, the apparatus can analyze the input data to determine characteristics of the input data. The characteristics are indicative of energy efficiency levels of the accelerators in performing the task. The apparatus can assign the task to one of the accelerators based on the characteristics for improved energy efficiency, in addition to balancing workloads for the accelerators. For example, the different types of accelerators can include accelerators configured to perform multiplication and accumulation using microring resonators, synapse memory cells, logical multiply-accumulate units, memristors, etc.

### RELATED APPLICATIONS

The present application claims priority to Prov. U.S. Pat. App. Ser. No. 63/485,466 filed Feb. 16, 2023, the entire disclosures of which application are hereby incorporated herein by reference.

### TECHNICAL FIELD

At least some embodiments disclosed herein relate to computations of multiplication and accumulation in general and more particularly, but not limited to, reduction of energy usage in computations of multiplication and accumulation.

### BACKGROUND

Many techniques have been developed to accelerate the computations of multiplication and accumulation. For example, multiple sets of logic circuits can be configured in arrays to perform multiplications and accumulations in parallel to accelerate multiplication and accumulation operations. For example, photonic accelerators have been developed to use phenomenon in optical domain to obtain computing results corresponding to multiplication and accumulation. For example, a memory sub-system can use a memristor crossbar or array to accelerate multiplication and accumulation operations in electrical domain.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows a heterogeneous accelerator sub-system according to one embodiment.

FIG. 2 shows the selection of an accelerator for a task of multiplication and accumulation according to one embodiment.

FIG. 3 shows an analog accelerator implemented using microring resonators for a heterogeneous accelerator sub-system according to one embodiment.

FIG. 4 shows another accelerator implemented using microring resonators for a heterogeneous accelerator sub-system according to one embodiment.

FIG. 5 shows the computation of a column of weight bits multiplied by a column of input bits to provide an accumulation result according to one embodiment.

FIG. 6 shows the computation of a column of multi-bit weights multiplied by a column of input bits to provide an accumulation result according to one embodiment.

FIG. 7 shows the computation of a column of multi-bit weights multiplied by a column of multi-bit inputs to provide an accumulation result according to one embodiment.

FIG. 8 shows a processing unit configured to perform matrix-matrix operations according to one embodiment.

FIG. 9 shows a processing unit configured to perform matrix-vector operations according to one embodiment.

FIG. 10 shows a processing unit configured to perform vector-vector operations according to one embodiment.

FIG. 11 shows an example computing system with a heterogeneous accelerator sub-system according to one embodiment.

FIG. 12 shows a method to perform operations of multiplication and accumulation according to one embodiment.

### DETAILED DESCRIPTION

At least some embodiments disclosed herein provide techniques of reducing the energy expenditure in computations of multiplication and accumulation. For example, a heterogeneous accelerator sub-system is configured with a plurality of heterogeneous accelerators. In response to a request to perform a task, the sub-system can analyze the characteristics of input data of the task and dynamically select an accelerator that consumes less energy for the given task.

A heterogeneous accelerator sub-system can have a plurality of accelerators for multiplication and acceleration. The accelerators can be implemented via different types of technologies, such as microring resonators, synapse memory cells, logic circuits, memristors, etc. As a result, the accelerators can have different energy consumption characteristics. An accelerator of a particular type can consume less energy, and thus advantageous in reduction of energy consumption, in performing computations for inputs having one set of characteristics but not in performing computations for inputs having another set of characteristics. The sub-system can assign computing tasks to accelerators of different types based at least in part on an analysis of the characteristics of input data of the computing tasks.

For example, such a heterogeneous accelerator sub-system can include an accelerator manager configured to orchestrate workloads of multiplication and accumulation across the heterogeneous accelerators configured in the sub-system (e.g., for deep learning computations). In response to a request to perform a task of multiplication and acceleration, the accelerator manager can select, from a plurality of heterogeneous accelerators, an accelerator for the task not only to balance workloads but also to reduce energy consumption.

For example, an accelerator implemented via microring resonators can consume less energy in performing a task than other types of accelerators when the input data of the task has large magnitudes (or can be transformed, e.g., via bitwise left shift, to have large magnitudes), or has fewer changes from the current states of the microring resonators (e.g., as maintained for performing a prior task), or both. Thus, when a given task has such characteristics, assigning the task to the accelerator implemented via microring resonators can be advantageous in reduction of energy consumption.

For example, an accelerator implemented via synapse memory cells can consume less energy in performing a task than other types of accelerators when most bits of the input data of the task have the value of zero (or can be transformed, e.g., via bit inversion, to have mostly zeros). Thus, when a given task has such characteristics, assigning the task to the accelerator implemented via synapse memory cells can be advantageous in reduction of energy consumption.

For example, an accelerator implemented via memristors can consume less energy in performing a task than other types of accelerators when the input data of the task has small magnitudes (or can be transformed, e.g., via bitwise right shift, to have small magnitudes). Thus, when a given task has such characteristics, assigning the tasks to the accelerator implemented via memristors can be advantageous in reduction of energy consumption.

For example, an accelerator implemented via logic circuits can consume less energy in performing a task than other types of accelerators (e.g., implemented via microring resonators, synapse memory cells, memristors) when the input data of the task have a wide distribution of magnitudes, and a relative even distributions of bits having the value of one and bits having the value of zero. Thus, when a given task has such characteristics, assigning the task to the accelerator implemented via logic circuits can be advantageous in reduction of energy consumption.

For example, such a heterogeneous accelerator sub-system can be configured in a data warehouse, or a server system, that has diverse tasks of multiplication and accumulation. Different tasks to be performed by the sub-system can be suitable for different types of accelerators in optimizing or reducing energy expenditures. The accelerator manager of the sub-system can be configured to balance loads for available accelerators in the system and reduce (or minimize) the energy expenditure in performing the tasks based at least in part on characteristics of input data of the tasks, such as a classification of the input data having large, small, or medium magnitudes (with or without optional transformation), a classification of bit value distribution of the input data the task (e.g., mostly ones or mostly zeros), a classification of the extent of changes of states of computing elements from a prior task, etc. The input data characteristics can be used to rank the energy efficiency of the accelerators in the sub-system in performing the diverse tasks and schedule tasks for execution by the accelerators with improved energy performance for the sub-system as a whole.

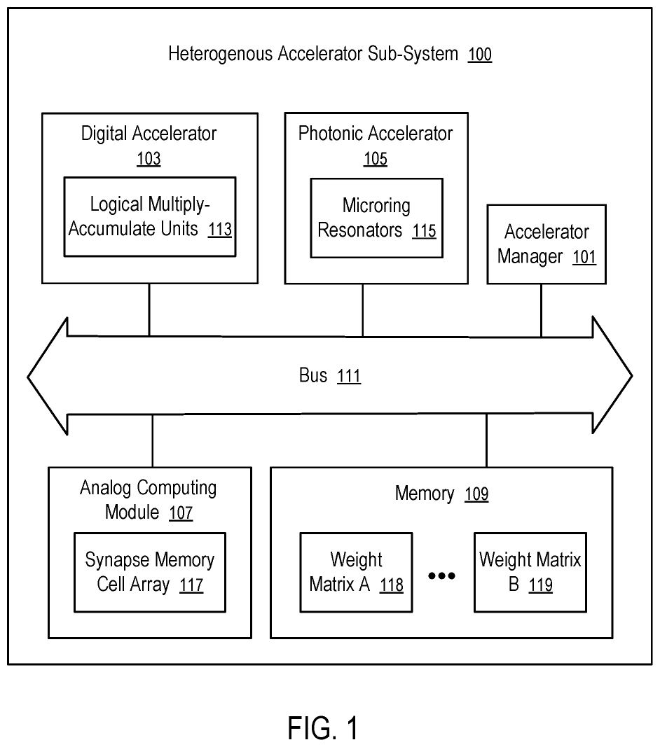

FIG. 1 shows a heterogeneous accelerator sub-system 100 according to one embodiment.

The heterogeneous accelerator sub-system 100 of FIG. 1 includes a bus 111 connecting a plurality of accelerators (e.g., 103, 105, 107) operable to perform operations of multiplication and accumulation, an accelerator manager 101, and memory 109 configured to store input data for the operations of multiplication and accumulation, such as weight matrices 118, . . . , 119.

The accelerators (e.g., 103, 105, 107) of the sub-system 100 can be of various different types, such as a digital accelerator 103 having logical multiply-accumulate units 113 as computing elements, a photonic accelerator 105 having microring resonators 115 as computing elements, an analog computing module 107 having an array 117 of synapse memory cells as computing elements, an accelerator having a crossbar of memristors as computing elements, etc.

In general, the heterogeneous accelerator sub-system 100 can have accelerators of any number of types, and any number of accelerators of any particular type. Thus, the combination of accelerators of the sub-system 100 is not limited to the example illustrated in FIG. 1; and more or less accelerators can be configured in the sub-system 100. For example, more than one photonic accelerator (e.g., 105) can be configured in the sub-system 100 in one implementation; the digital accelerator 103 (or the analog computing module 107) can be omitted in another implementation; and one or more memristor accelerators (or another type of accelerators) can be included in a further implementation.

The accelerator manager 101 of the sub-system 100 can be configured to manage the workloads of the accelerators (e.g., 103, 105, 107) of the sub-system 100. A request to perform a task of multiplication and accumulation can be directed to the accelerator manager 101. The request can include identification of input data for the task stored in the memory 109, such as a weight matrix (e.g., 118 or 119), and an input to be weighted according to the weight matrix (e.g., 118 or 119) through an operation of multiplication and accumulation.

The accelerator manager 101 can analyze the input data identified for a task to determine the energy efficiency rankings of the available accelerators (e.g., 103, 105, 107) in performing the task. Based on the energy efficiency rankings, workloads of the accelerators, and availability of the accelerators, the accelerator manager 101 can select an accelerator (e.g., 103, 105, or 107) to perform the task, and assign the task for performance by the selected accelerator (e.g., 103, 105, or 107).

For example, when there are multiple choices of accelerators to perform the task based on load balancing and availability, the accelerator manager 101 can select an accelerator that can consume the least amount of energy for the task and assign the task to the selected accelerator.

Optionally, the accelerator manager 101 can transform the input data to reduce the energy expenditure of the accelerator selected to perform the task. For example, when the photonic accelerator 105 is selected for the task, the accelerator manager 101 can bitwise shift the input data (e.g., weight matrix 118 or 119) to increase the magnitudes of the input data, and perform reverse bitwise shift on the computation result produced by the photonic accelerator 105 for the task. For example, when a memristor accelerator is selected for the task, the accelerator manager 101 can bitwise shift the input data (e.g., weight matrix 118 or 119) to decrease the magnitudes of the input data, and perform reverse bitwise shift on the computation result produced by the memristor accelerator 105 for the task. For example, when an analog computing module 107 is selected for the task, the accelerator manager 101 can invert the bit values of the input data to increase the ratio of bits having the value of zero, and adjust the computing result produce by the analog computing module 107 to generate the corresponding result for the non-inverted input data.

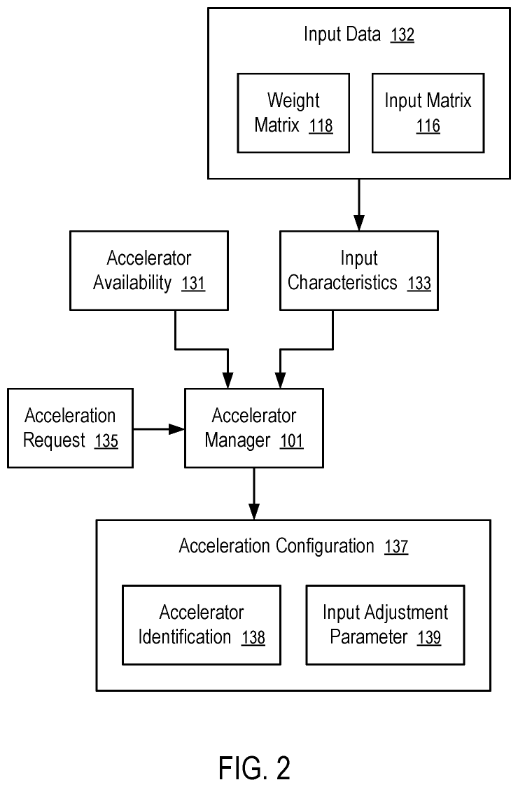

FIG. 2 shows the selection of an accelerator for a task of multiplication and accumulation according to one embodiment. For example, the heterogeneous accelerator sub-system 100 of FIG. 1 can be configured to assign computing tasks of multiplication and accumulation in a way as illustrated in FIG. 2.

In FIG. 2, an accelerator manager 101 is configured to receive acceleration request 135 that identifies input data 132 of applying a weight matrix 118 to an input matrix 116 via multiplication and accumulation.

The accelerator manager 101 can use one of a plurality of heterogeneous accelerators (e.g., 103, 105, 107) to perform the task identified in the request 135. To select an accelerator for the task, the accelerator manager 101 can check the availability 131 of the accelerators (e.g., 103, 105, 107) configured in the sub-system 100. When there are multiple accelerators (e.g., 103, 105, 107) available to perform the task (e.g., immediately or after a predetermined period of time), the accelerator manager 101 can analyze the input data 132 to determine the input characteristics 133 for ranking the energy efficiency performances of the available accelerators (e.g., 103, 105, 107).

Optionally, the accelerator manager 101 can be configured to optimize a cost function to balance the performance levels of the sub-system 100 in response time (e.g., reduced latency in providing computation results) and in energy consumption.

Optionally, the accelerator manager 101 can be configured to use a set of criteria to select candidates based on balancing workloads under a response time constraint. Then, an accelerator having best energy performance among the candidates is selected to perform the task.

In response to selecting an accelerator to perform a task, the accelerator manager 101 can generate an acceleration configuration 137 for the request 135. The acceleration configuration 137 can include an identification 138 of an accelerator (e.g., 103, 105, or 107) selected to perform the task having the input 132, and an optional parameter 139 configured to adjust the input data 132 to improve the energy efficiency of the sub-system 100 in performing the task using the selected accelerator (e.g., 103, 105, or 107). The heterogeneous accelerator sub-system 100 can perform the task identified by the request 135 according to the acceleration configuration 137.

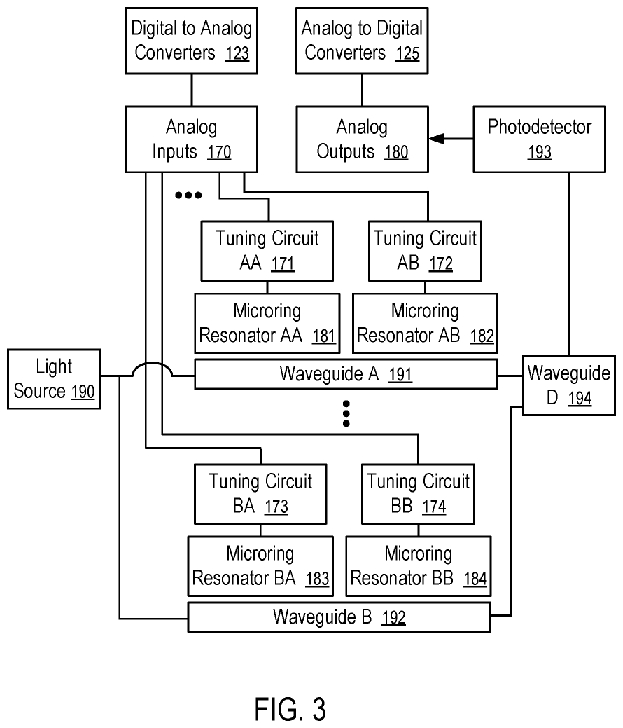

FIG. 3 shows an analog accelerator implemented using microring resonators for a heterogeneous accelerator sub-system according to one embodiment. For example, the photonic accelerator 105 of the heterogeneous accelerator sub-system 100 of FIG. 1 can be implemented in a way as in FIG. 3.

In FIG. 3, digital to analog converters 123 can convert digital inputs (e.g., input matrix 116) into corresponding analog inputs 170; and analog outputs 180 can be converted to digital forms via analog to digital converters 125.

The analog accelerator of FIG. 3 has microring resonators 181, 182, . . . , 183, and 184, and a light source 190 (e.g., a semiconductor laser diode, such as a vertical-cavity surface-emitting laser (VCSEL)) configured to feed light inputs into waveguides 191, . . . , 192.

Each of the waveguides (e.g., 191 or 192) is configured with multiple microring resonators (e.g., 181, 182; or 183, 184) to change the magnitude of the light going through the respective waveguide (e.g., 191 or 192).

A tuning circuit (e.g., 171, 172, 173, or 174) of a microring resonator (e.g., 181, 182, 183, or 184) can change resonance characteristics of the microring resonator (e.g., 181, 182, 183, or 184) through heat or carrier injection.

Thus, the ratio between the magnitude of the light coming out of the waveguide (e.g., 191) to enter a combining waveguide 194 and the magnitude of the light going into the waveguide (e.g., 191) near the light source 190 is representative of the multiplications of attenuation factors implemented via tuning circuits (e.g., 171 and 172) of microring resonators (e.g., 181 and 182) in electromagnetic interaction with the waveguide (e.g., 191).

The combining waveguide 194 sums the results of the multiplications performed via the lights going through the waveguides 191, . . . , 192. A photodetector 193 is configured to convert the combined optical outputs from the waveguide into analog outputs 180 in the electrical domain.

For example, a set of inputs from the input matrix 116 can be applied as a portion of analog inputs 170 to the tuning circuits 171, . . . , 173; and a set of weight elements from a row of the weight matrix 118 can be applied via another portion of analog inputs 170 to the tuning circuits 172, . . . , 174; and the output of the combining waveguide 194 to the photodetector 193 represents the multiplication and accumulation between the set of inputs weight via the set of weight elements. Analog to digital converters 125 can convert the analog outputs 180 into an output.

The same set of input elements as applied via the tuning circuits 171, . . . , 173 can be maintained while a set of weight elements from a next row of the weight matrix 118 can be applied via a portion of analog inputs 170 to the tuning circuits 172, . . . , 174 to perform the multiplication and accumulation of weights of the next row to the input elements. After completion of the computations involving the same set of input elements, a next set of input elements can be loaded from the input matrix 116 in the memory 109.

Alternatively, a same set of weight elements from a row of the weight matrix 118 can be maintained (e.g., via a portion of analog inputs 170 to the tuning circuits 172, . . . , 174) for different sets of input elements. After completion of the computations involving the same set of weight elements, a next set of weight elements can be loaded from the weight matrix 118 in the memory 109.

Alternatively, inputs can be applied via the tuning circuits 172, . . . , 174; and weight elements can be applied via the tuning circuits 171, . . . , 173.

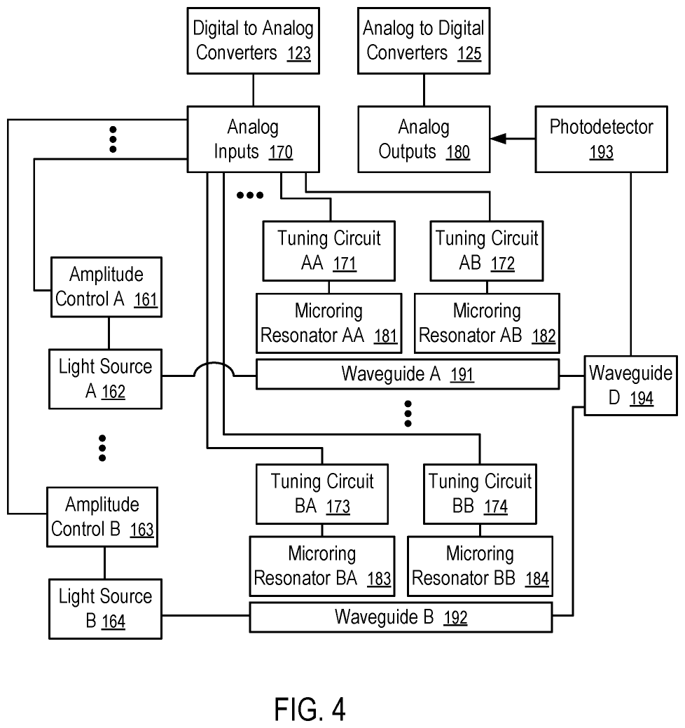

FIG. 4 shows another accelerator implemented using microring resonators for a heterogeneous accelerator sub-system according to one embodiment. For example, the photonic accelerator 105 of the heterogeneous accelerator sub-system 100 of FIG. 1 can be implemented in a way as in FIG. 4.

Similar to the analog accelerator of FIG. 3, the analog accelerator of FIG. 4 has microring resonators 181, 182, . . . , 183, and 184 with tuning circuits 171, 172, . . . , 173, and 174, waveguides 191, . . . , and 192, and a combining waveguide 194.

In FIG. 4, the analog accelerator has amplitude controls 161, . . . , and 163 for light sources 162, 164 connected to the waveguides 191, . . . , and 192 respectively. Thus, the amplitudes of the lights going into the waveguides 191, . . . , and 192 are controllable via a portion of analog inputs 170 connected to the amplitude controls 161, . . . , 163. The amplitude of the light coming out of a waveguide (e.g., 191) is representative of the multiplications of the input to the amplitude control (e.g., 161) of the light source (e.g., 162) of the waveguide (e.g., 191) and the inputs to the tuning circuits (e.g., 171 and 172) of microring resonators (e.g., 181 and 182) interacting with the waveguide (e.g., 191).

For example, inputs from the input matrix 116 can be applied via the amplitude controls 161, . . . , 163; weight elements from the weight matrix 118 can be applied via the tuning circuits 171, . . . , 173 (or 172, . . . , 174); and an optional scaling factor can also be applied via the tuning circuits 172, . . . , 174 (or 171, . . . , 173).

Alternatively, inputs from the input matrix 116 can be applied via the tuning circuits 171, . . . , 173 (or 172, . . . , 174); and weight elements from the weight matrix 118 can be applied via the amplitude controls 161, . . . , 163.

Optionally, microring resonators 182, . . . , 184 and their tuning circuits 172, . . . , 174 can be omitted. A scaling factor can be applied by the accelerator manager 101.

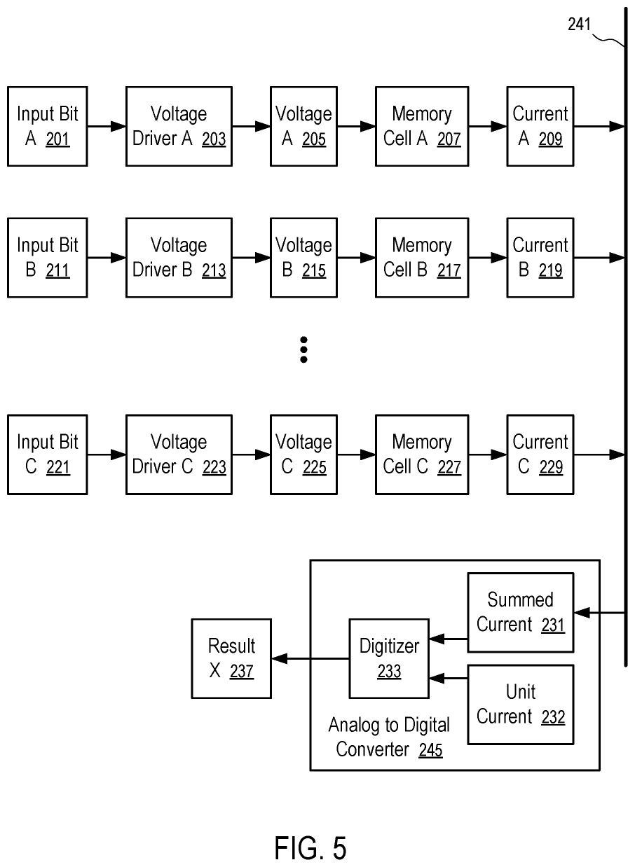

FIG. 5 shows the computation of a column of weight bits multiplied by a column of input bits to provide an accumulation result according to one embodiment. For example, the synapse memory cell array 117 in an analog computing module 107 of FIG. 1 can be configured in a way as illustrated in FIG. 5 to perform operations of multiplication and accumulation.

In FIG. 5, a column of synapse memory cells 207, 217, . . . , 227 (e.g., in the memory cell array 117 of an analog computing module 107) can be programmed in the synapse mode to have threshold voltages at levels representative of weights stored one bit per memory cell.

The column of memory cells 207, 217, . . . , 227, programmed in the synapse mode, can be read in a synapse mode, during which voltage drivers 203, 213, . . . , 223 are configured to apply voltages 205, 215, . . . , 225 concurrently to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . , 227 are connected to a common line 241 (e.g., bitline) for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 5, the voltages 205, 215, . . . , 225 applied to the memory cells 207, 217, . . . 227 are representative of digitized input bits 201, 211, . . . , 221; the memory cells 207, 217, . . . , 227 are programmed to store digitized weight bits; and the currents 209, 219, . . . , 229 are representative of digitized results. Thus, the memory cells 207, 217, . . . , 227 do not function as memristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 5 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

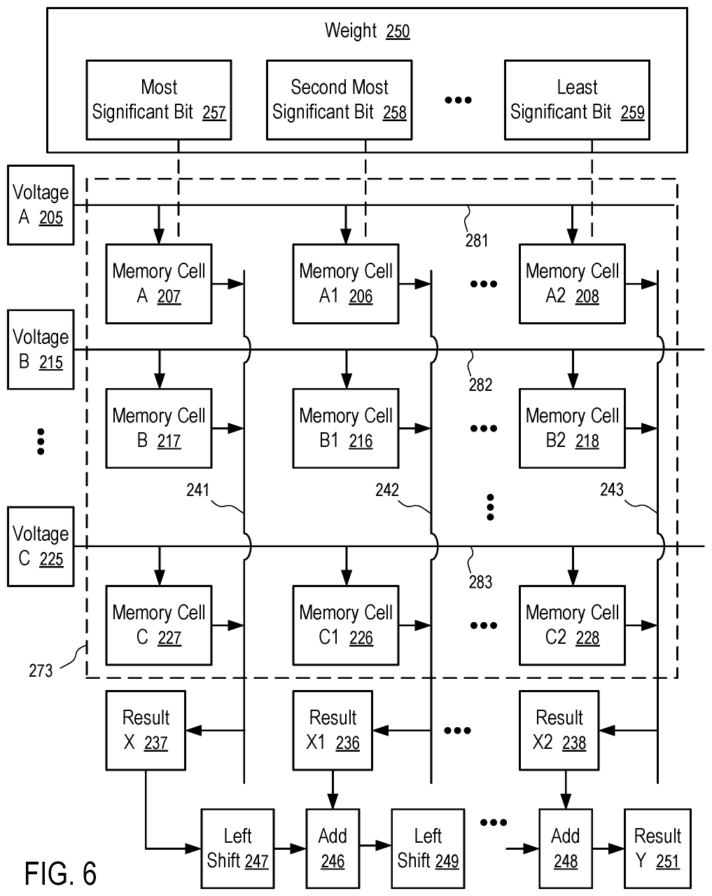

In general, a weight involving a multiplication and accumulation operation can be more than one bit. Multiple columns of memory cells can be used to store the different significant bits of weights, as illustrated in FIG. 6 to perform multiplication and accumulation operations.

The circuit illustrated in FIG. 5 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 6.

The circuit illustrated in FIG. 5 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 5 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 6 shows the computation of a column of multi-bit weights multiplied by a column of input bits to provide an accumulation result according to one embodiment.

In FIG. 6, a weight 250 in a binary form has a most significant bit 257, a second most significant bit 258, . . . , a least significant bit 259. The significant bits 257, 258, . . . , 259 can be stored in a rows of memory cells 207, 206, . . . , 208 (e.g., in the memory cell array 117 of an analog computing module 107) across a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 5).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 5); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 5).

The most significant bits (e.g., 257) of the weights (e.g., 250) stored in the respective rows of memory cells in the array 273 are multiplied by the input bits 201, 211, . . . 221 represented by the voltages 205, 215, . . . , 225 and then summed as the current 231 in a line 241 and digitized using a digitizer 233, as in FIG. 5, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

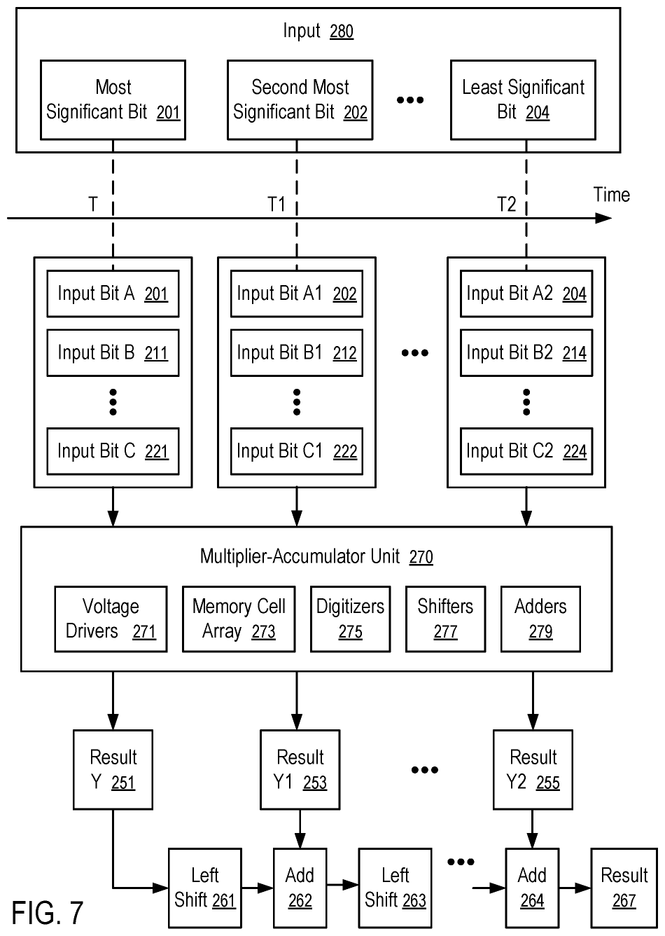

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 7.

The circuit illustrated in FIG. 6 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . , 248 provides the weight 250 in a binary form.

In general, the circuit illustrated in FIG. 6 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 7 shows the computation of a column of multi-bit weights multiplied by a column of multi-bit inputs to provide an accumulation result according to one embodiment.

In FIG. 7, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 6. The multiplier-accumulator unit 270 has voltage drivers 271 connected to apply voltages 205, 215, . . . , 225 representative of the input bits 201, 211, . . . , 221. The multiplier-accumulator unit 270 has a memory cell array 273 storing bits of weights as in FIG. 6. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 6. In some implementations, the logic circuits of the multiplier-accumulator unit 270 (e.g., shifters 277 and adders 279) are implemented as part of the inference logic circuit of the analog computing module 107.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280). The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

The analog computing module 107 of FIG. 1 can be configured to perform operations of multiplication and accumulation in a way as illustrated in FIG. 5, FIG. 6, and FIG. 7.

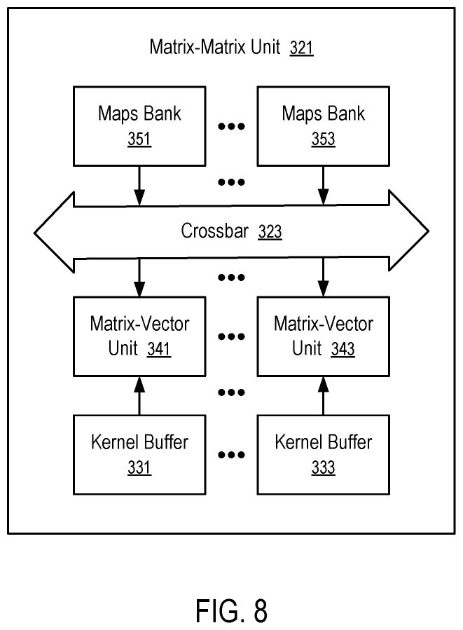

FIG. 8 shows a processing unit 321 configured to perform matrix-matrix operations according to one embodiment. For example, the logical multiply-accumulate units 113 of the digital accelerator 103 can be configured as the matrix-matrix unit 321 of FIG. 8.

In FIG. 8, the matrix-matrix unit 321 includes multiple kernel buffers 331 to 333 and multiple maps banks 351 to 353. Each of the maps banks 351 to 353 stores one vector of a matrix operand that has multiple vectors stored in the maps banks 351 to 353 respectively; and each of the kernel buffers 331 to 333 stores one vector of another matrix operand that has multiple vectors stored in the kernel buffers 331 to 333 respectively. The matrix-matrix unit 321 is configured to perform multiplication and accumulation operations on the elements of the two matrix operands, using multiple matrix-vector units 341 to 343 that operate in parallel.

A crossbar 323 connects the maps banks 351 to 353 to the matrix-vector units 341 to 343. The same matrix operand stored in the maps bank 351 to 353 is provided via the crossbar 323 to each of the matrix-vector units 341 to 343; and the matrix-vector units 341 to 343 receives data elements from the maps banks 351 to 353 in parallel. Each of the kernel buffers 331 to 333 is connected to a respective one in the matrix-vector units 341 to 343 and provides a vector operand to the respective matrix-vector unit. The matrix-vector units 341 to 343 operate concurrently to compute the operation of the same matrix operand, stored in the maps banks 351 to 353 multiplied by the corresponding vectors stored in the kernel buffers 331 to 333. For example, the matrix-vector unit 341 performs the multiplication operation on the matrix operand stored in the maps banks 351 to 353 and the vector operand stored in the kernel buffer 331, while the matrix-vector unit 343 is concurrently performing the multiplication operation on the matrix operand stored in the maps banks 351 to 353 and the vector operand stored in the kernel buffer 333.

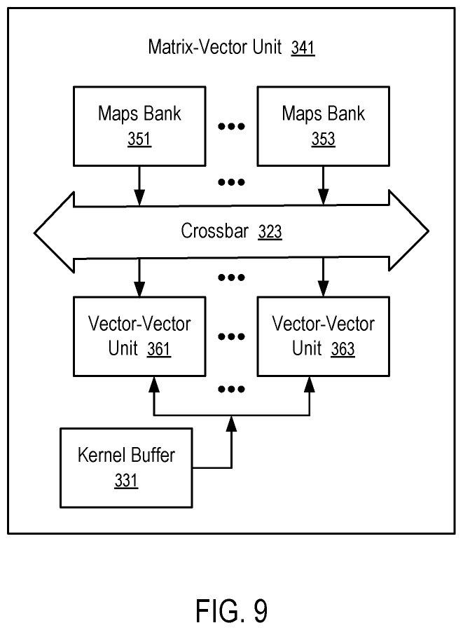

Each of the matrix-vector units 341 to 343 in FIG. 8 can be implemented in a way as illustrated in FIG. 9.

FIG. 9 shows a processing unit 341 configured to perform matrix-vector operations according to one embodiment. For example, the matrix-vector unit 341 of FIG. 9 can be used as any of the matrix-vector units in the matrix-matrix unit 321 of FIG. 8.

In FIG. 9, each of the maps banks 351 to 353 stores one vector of a matrix operand that has multiple vectors stored in the maps banks 351 to 353 respectively, in a way similar to the maps banks 351 to 353 of FIG. 8. The crossbar 323 in FIG. 9 provides the vectors from the maps banks 351 to the vector-vector units 361 to 363 respectively. A same vector stored in the kernel buffer 331 is provided to the vector-vector units 361 to 363.

The vector-vector units 361 to 363 operate concurrently to compute the operation of the corresponding vector operands, stored in the maps banks 351 to 353 respectively, multiplied by the same vector operand that is stored in the kernel buffer 331. For example, the vector-vector unit 361 performs the multiplication operation on the vector operand stored in the maps bank 351 and the vector operand stored in the kernel buffer 331, while the vector-vector unit 363 is concurrently performing the multiplication operation on the vector operand stored in the maps bank 353 and the vector operand stored in the kernel buffer 331.

When the matrix-vector unit 341 of FIG. 9 is implemented in a matrix-matrix unit 321 of FIG. 8, the matrix-vector unit 341 can use the maps banks 351 to 353, the crossbar 323 and the kernel buffer 331 of the matrix-matrix unit 321.

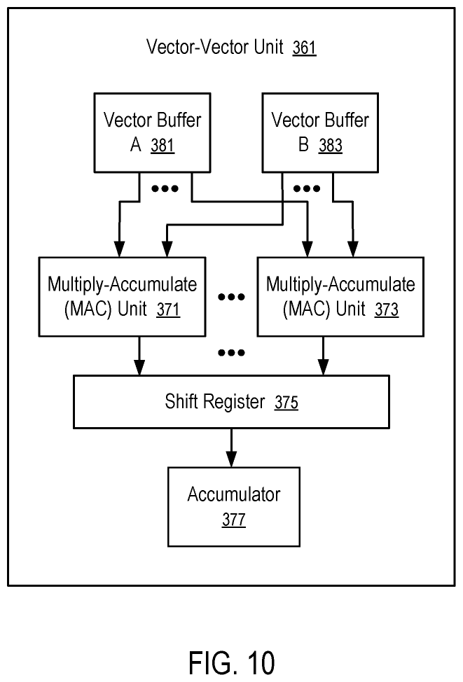

Each of the vector-vector units 361 to 363 in FIG. 9 can be implemented in a way as illustrated in FIG. 10.

FIG. 10 shows a processing unit 361 configured to perform vector-vector operations according to one embodiment. For example, the vector-vector unit 361 of FIG. 10 can be used as any of the vector-vector units in the matrix-vector unit 341 of FIG. 9.

In FIG. 10, the vector-vector unit 361 has multiple multiply-accumulate (MAC) units 371 to 373. Each of the multiply-accumulate (MAC) units 371 to 373 can receive two numbers as operands, perform multiplication of the two numbers, and add the result of the multiplication to a sum maintained in the multiply-accumulate (MAC) unit.

Each of the vector buffers 381 and 383 stores a list of numbers. A pair of numbers, each from one of the vector buffers 381 and 383, can be provided to each of the multiply-accumulate (MAC) units 371 to 373 as input. The multiply-accumulate (MAC) units 371 to 373 can receive multiple pairs of numbers from the vector buffers 381 and 383 in parallel and perform the multiply-accumulate (MAC) operations in parallel. The outputs from the multiply-accumulate (MAC) units 371 to 373 are stored into the shift register 375; and an accumulator 377 computes the sum of the results in the shift register 375.

When the vector-vector unit 361 of FIG. 10 is implemented in a matrix-vector unit 341 of FIG. 9, the vector-vector unit 361 can use a maps bank (e.g., 351 or 353) as one vector buffer 381, and the kernel buffer 331 of the matrix-vector unit 341 as another vector buffer 383.

The vector buffers 381 and 383 can have the same length to store the same number/count of data elements. The length can be equal to, or the multiple of, the count of multiply-accumulate (MAC) units 371 to 373 in the vector-vector unit 361. When the length of the vector buffers 381 and 383 is the multiple of the count of multiply-accumulate (MAC) units 371 to 373, a number of pairs of inputs, equal to the count of the multiply-accumulate (MAC) units 371 to 373, can be provided from the vector buffers 381 and 383 as inputs to the multiply-accumulate (MAC) units 371 to 373 in each iteration; and the vector buffers 381 and 383 feed their elements into the multiply-accumulate (MAC) units 371 to 373 through multiple iterations.

In one embodiment, the communication bandwidth of the bus 111 between the digital accelerator 103 and the memory 109 is sufficient for the matrix-matrix unit 321 to use portions of the memory 109 as the maps banks 351 to 353 and the kernel buffers 331 to 333.

In another embodiment, the maps banks 351 to 353 and the kernel buffers 331 to 333 are implemented in a portion of the local memory of the digital accelerator 103. The communication bandwidth of the bus 111 between the digital accelerator 103 and the memory 109 sufficient to load, into another portion of the local memory, matrix operands of the next operation cycle of the matrix-matrix unit 321, while the matrix-matrix unit 321 is performing the computation in the current operation cycle using the maps banks 351 to 353 and the kernel buffers 331 to 333 implemented in a different portion of the local memory of the digital accelerator 103.

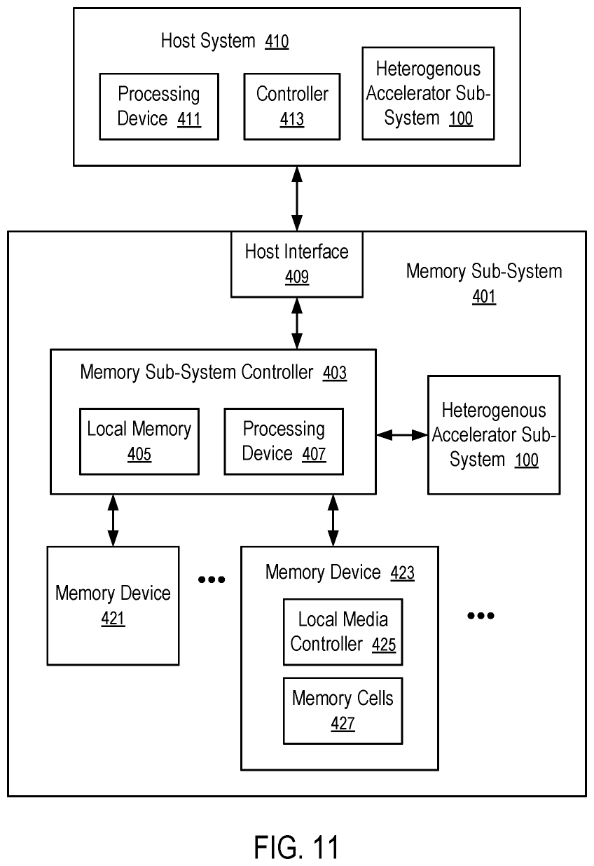

FIG. 11 shows an example computing system with a heterogeneous accelerator sub-system according to one embodiment.

The example computing system of FIG. 11 includes a host system 410 and a memory sub-system 401. A heterogeneous accelerator sub-system 100 (e.g., implemented as in FIG. 1) can be configured in the memory sub-system 401, or in the host system 410. In some implementations, a portion of the heterogeneous accelerator sub-system 100 (e.g., accelerator manager 101, an accelerator) is implemented in the memory sub-system 401, and another portion of the heterogeneous accelerator sub-system 100 (e.g., memory 109, analog computing module 107, another accelerator) is implemented in the host system 410.

The memory sub-system 401 can include media, such as one or more volatile memory devices (e.g., memory device 421), one or more non-volatile memory devices (e.g., memory device 423), or a combination of such.

A memory sub-system 401 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system can include a host system 410 that is coupled to one or more memory sub-systems 401. FIG. 11 illustrates one example of a host system 410 coupled to one memory sub-system 401. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 410 can include a processor chipset (e.g., processing device 411) and a software stack executed by the processor chipset. The processor chipset can include one or more cores, one or more caches, a memory controller (e.g., controller 413) (e.g., NVDIMM controller), and a storage protocol controller (e.g., PCIe controller, SATA controller). The host system 410 uses the memory sub-system 401, for example, to write data to the memory sub-system 401 and read data from the memory sub-system 401.

The host system 410 can be coupled to the memory sub-system 401 via a physical host interface 409. Examples of a physical host interface 409 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, or any other interface. The physical host interface 409 can be used to transmit data between the host system 410 and the memory sub-system 401. The host system 410 can further utilize an NVM express (NVMe) interface to access components (e.g., memory devices 423) when the memory sub-system 401 is coupled with the host system 410 by the PCIe interface. The physical host interface 409 can provide an interface for passing control, address, data, and other signals between the memory sub-system 401 and the host system 410. FIG. 11 illustrates a memory sub-system 401 as an example. In general, the host system 410 can access multiple memory sub-systems via a same communication connection, multiple separate communication connections, and/or a combination of communication connections.

The processing device 411 of the host system 410 can be, for example, a microprocessor, a central processing unit (CPU), a processing core of a processor, an execution unit, etc. In some instances, the controller 413 can be referred to as a memory controller, a memory management unit, and/or an initiator. In one example, the controller 413 controls the communications over a bus coupled between the host system 410 and the memory sub-system 401. In general, the controller 413 can send commands or requests to the memory sub-system 401 for desired access to memory devices 423, 421. The controller 413 can further include interface circuitry to communicate with the memory sub-system 401. The interface circuitry can convert responses received from the memory sub-system 401 into information for the host system 410.

The controller 413 of the host system 410 can communicate with the controller 403 of the memory sub-system 401 to perform operations such as reading data, writing data, or erasing data at the memory devices 423, 421 and other such operations. In some instances, the controller 413 is integrated within the same package of the processing device 411. In other instances, the controller 413 is separate from the package of the processing device 411. The controller 413 and/or the processing device 411 can include hardware such as one or more integrated circuits (ICs) and/or discrete components, a buffer memory, a cache memory, or a combination thereof. The controller 413 and/or the processing device 411 can be a microcontroller, special purpose logic circuitry (e.g., a field programmable gate array (FPGA), an application specific integrated circuit (ASIC), etc.), or another suitable processor.

The memory devices 423, 421 can include any combination of the different types of non-volatile memory components and/or volatile memory components. The volatile memory devices (e.g., memory device 421) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 423 can include one or more arrays of memory cells 427. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 423 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 423 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 423 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 403 (or controller 403 for simplicity) can communicate with the memory devices 423 to perform operations such as reading data, writing data, or erasing data at the memory devices 423 and other such operations (e.g., in response to commands scheduled on a command bus by controller 413). The controller 403 can include hardware such as one or more integrated circuits (ICs) and/or discrete components, a buffer memory, or a combination thereof. The hardware can include digital circuitry with dedicated (i.e., hard-coded) logic to perform the operations described herein. The controller 403 can be a microcontroller, special purpose logic circuitry (e.g., a field programmable gate array (FPGA), an application specific integrated circuit (ASIC), etc.), or another suitable processor.

The controller 403 can include a processing device 407 (processor) configured to execute instructions stored in a local memory 405. In the illustrated example, the local memory 405 of the controller 403 includes an embedded memory configured to store instructions for performing various processes, operations, logic flows, and routines that control operation of the memory sub-system 401, including handling communications between the memory sub-system 401 and the host system 410.

In some embodiments, the local memory 405 can include memory registers storing memory pointers, fetched data, etc. The local memory 405 can also include read-only memory (ROM) for storing micro-code. While the example memory sub-system 401 in FIG. 11 has been illustrated as including the controller 403, in another embodiment of the present disclosure, a memory sub-system 401 does not include a controller 403, and can instead rely upon external control (e.g., provided by an external host, or by a processor or controller separate from the memory sub-system).

In general, the controller 403 can receive commands or operations from the host system 410 and can convert the commands or operations into instructions or appropriate commands to achieve the desired access to the memory devices 423. The controller 403 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 423. The controller 403 can further include host interface circuitry to communicate with the host system 410 via the physical host interface. The host interface circuitry can convert the commands received from the host system into command instructions to access the memory devices 423 as well as convert responses associated with the memory devices 423 into information for the host system 410.

The memory sub-system 401 can also include additional circuitry or components that are not illustrated. In some embodiments, the memory sub-system 401 can include a cache or buffer (e.g., DRAM) and address circuitry (e.g., a row decoder and a column decoder) that can receive an address from the controller 403 and decode the address to access the memory devices 423.

In some embodiments, the memory devices 423 include local media controllers 425 that operate in conjunction with the memory sub-system controller 403 to execute operations on one or more memory cells of the memory devices 423. An external controller (e.g., memory sub-system controller 403) can externally manage the memory device 423 (e.g., perform media management operations on the memory device 423). In some embodiments, a memory device 423 is a managed memory device, which is a raw memory device combined with a local controller (e.g., local controller 425) for media management within the same memory device package. An example of a managed memory device is a managed NAND (MNAND) device.

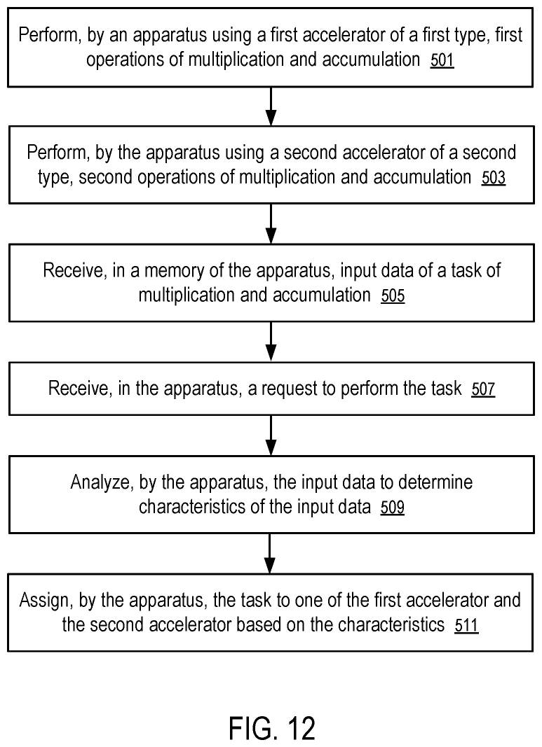

FIG. 12 shows a method to perform operations of multiplication and accumulation according to one embodiment. For example, the method can be implemented in a computing system or device of FIG. 11.

For example, a computing device or apparatus (e.g., as in FIG. 11) can have a heterogeneous accelerator sub-system 100 configured as in FIG. 1. The heterogeneous accelerator sub-system 100 can have a plurality of accelerators of different types, such as a photonic accelerator 105 implemented as in FIG. 3 or FIG. 4, an analog computing module 107 with an array of synapse memory cells configured to perform operations of multiplication and accumulation as in FIG. 5, FIG. 6, and FIG. 7, a digital accelerator 103 having a matrix-matrix unit 321 configured as in FIG. 8, FIG. 9, and FIG. 10, an accelerator having memristors configured as computing elements, etc.

The heterogeneous accelerator sub-system 100 can have an accelerator manager 101 configured to analyze input data 132 specified in the memory 109 for a request 135 to perform an operation of multiplication and accumulation on the input data 132. Based on input characteristics 133 of the input data 132, the accelerator manager 101 can determine an acceleration configuration 137 for the processing of the task identified by the request 135. The acceleration configuration 137 can include the identification 138 of an accelerator (e.g., 103, 105, 107) selected to perform the task, based at least in part that the accelerator (e.g., 103, 105, 107) is determined to be energy efficient in processing of input data 132 having the input characteristics 133. Optionally, the acceleration configuration 137 can include an optional parameter 139 configured to transform the input data 132 for processing by the selected accelerator for improved energy efficiency.

At block 501, an apparatus performs, using a first accelerator of a first type, first operations of multiplication and accumulation.

At block 503, the apparatus performs, using a second accelerator of a second type, second operations of multiplication and accumulation.

For example, the apparatus can be a heterogeneous accelerator sub-system 100, a memory sub-system 401 (or a host system 410) having the heterogeneous accelerator sub-system 100, or a computing device or system having the heterogeneous accelerator sub-system 100.

Optionally, the apparatus can perform, using a third accelerator of a third type, third operations of multiplication and accumulation.

For example, the first type of accelerators, the second type of accelerators, and the third type of accelerators can be different types of accelerators, such as photonic accelerators (e.g., 105) with microring resonators as computing elements, analog computing modules (e.g., 107) configured with synapse memory cells as computing elements, digital accelerators (e.g., 103) configured with parallel logical circuits as computing elements, memristor accelerators configured with memristors as computing elements, etc.

The different types of accelerators can be operable to perform a same operation of multiplication and accumulation. Thus, a task of accelerating an operation of multiplication and accumulation can be assigned to any of the accelerators of the apparatus. However, performing the same task using accelerators of different types can consume different amounts of energy. The accelerator manager 101 can be configured to rank energy efficiency of the first accelerator, the second accelerator, and the third accelerator based on the characteristics of the input data 132 of the task to select one of the accelerators for performance of the task with reduced or optimized energy expenditure.

At block 505, the apparatus receives, in a memory 109, input data 132 of a task of multiplication and accumulation.

At block 507, the apparatus receives a request 135 to perform the task.

At block 509, the apparatus analyzes the input data 132 to determine characteristics 133 of the input data 132.

For example, the input characteristics 133 can include: an indication of whether magnitudes of elements in the input data are clustered near a high region of magnitude distribution; an indication of whether magnitudes of elements in the input data are clustered near a low region of magnitude distribution; an indication of a ratio between a count of bits of elements in the input data having a value of one and a count of bits of elements in the input data having a value of zero; or an indication of similarity between the input data and corresponding input data of a respective task performed in each of the first accelerator, the second accelerator, and the third accelerator, or any combination of the indications.

The input characteristics 133 can be used to compare the energy efficiency of the accelerators of different types (e.g., via a set of predetermined rules, or a predictive formula or model).

At block 511, the apparatus assigns the task to one of the first accelerator and the second accelerator (and optionally the third accelerator) based on the characteristics 133.

For example, the accelerator manager 101 can be configured to assign the task to one of the first accelerator, the second accelerator, and the third accelerator further based on availability 131 of the first accelerator, the second accelerator, and the third accelerator, and based on the input characteristics 133.

For example, the accelerator manager 101 can assign tasks in a way to balance workloads of the accelerators to avoid excessive delay, while minimizing the total energy expenditure.

For example, the accelerator manager 101 can assign tasks by optimizing a cost function that is configured to balance a goal to reduce time gaps between receiving requests (e.g., 135) to perform tasks (e.g., for the input data 132) and the completion of the tasks, and a goal to reduce the energy consumption for performing the tasks.

Optionally, the accelerator manager 101 can further identify a parameter to adjust the input data 132 via bitwise shifting or bit value inversion to reduce the energy consumption in performance of the task by a selected accelerator (e.g., 105, or 107).

For example, the energy consumption of the photonic accelerator 105 can be reduced by shifting bits of input data 132 left to increase magnitudes of data elements to be applied via microring resonators 115.

For example, the energy consumption of the memristor accelerator can be reduced by shifting bits of input data 132 right to decrease magnitudes of data elements to be applied via memristors.

For example, the energy consumption of the analog computing model 107 can be reduced by optionally inverting bit values to have more bits having the value of zero than bits having the value of one.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
a first accelerator of a first type, the first accelerator operable to perform operations of multiplication and accumulation;
a second accelerator of a second type, the second accelerator operable to perform the operations of multiplication and accumulation;
a memory configured to store input data of a task of multiplication and accumulation; and
an accelerator manager configured to:
receive a request to perform the task;
analyze the input data to determine characteristics of the input data;
assign the task to one of the first accelerator and the second accelerator based on the characteristics.

2. The apparatus of claim 1, wherein accelerators of the first type are configured with microring resonators as computing elements.

3. The apparatus of claim 2, wherein accelerators of the second type are configured with synapse memory cells as computing elements.

4. The apparatus of claim 1, further comprising:
a third accelerator of a third type, the third accelerator operable to perform the operations of multiplication and accumulation;
wherein the accelerator manager is configured to rank energy efficiency of the first accelerator, the second accelerator, and the third accelerator based on the characteristics to assign the task to one of the first accelerator, the second accelerator, and the third accelerator.

5. The apparatus of claim 4, wherein the first type, the second type, and the third type are different types from:
photonic accelerators;
analog computing modules;
digital accelerators; and
memristor accelerators.

6. The apparatus of claim 5, wherein the characteristics include at least:
an indication of whether magnitudes of elements in the input data are clustered near a high region of magnitude distribution;
an indication of whether magnitudes of elements in the input data are clustered near a low region of magnitude distribution; or
an indication of a ratio between a count of bits of elements in the input data having a value of one and a count of bits of elements in the input data having a value of zero.

7. The apparatus of claim 6, wherein the accelerator manager is configured to assign the task to one of the first accelerator, the second accelerator, and the third accelerator further based on availability of the first accelerator, the second accelerator, and the third accelerator.

8. The apparatus of claim 7, wherein the characteristics further include an indication of similarity between the input data and corresponding input data of a respective task performed in each of the first accelerator, the second accelerator, and the third accelerator.

9. The apparatus of claim 7, wherein the accelerator manager is configured to identify a parameter to adjust the input data via bitwise shifting.

10. The apparatus of claim 7, wherein the accelerator manager is configured to identify a parameter to adjust the input data via bit value inversion.

11. A method, comprising:
performing, by an apparatus using a first accelerator of a first type, first operations of multiplication and accumulation;
performing, by the apparatus using a second accelerator of a second type, second operations of multiplication and accumulation;
receiving, in a memory of the apparatus, input data of a task of multiplication and accumulation;
receiving, in the apparatus, a request to perform the task;
analyzing, by the apparatus, the input data to determine characteristics of the input data; and
assigning, by the apparatus, the task to one of the first accelerator and the second accelerator based on the characteristics.

12. The method of claim 11, further comprising:
performing, by the apparatus using a third accelerator of a third type, third operations of multiplication and accumulation; and
ranking, by the apparatus, energy efficiency of the first accelerator, the second accelerator, and the third accelerator based on the characteristics to assign the task to one of the first accelerator, the second accelerator, and the third accelerator.

13. The method of claim 12, wherein the first type, the second type, and the third type are different types from:
photonic accelerators;
analog computing modules;
digital accelerators; and
memristor accelerators.

14. The method of claim 13, wherein the characteristics include at least:
an indication of whether magnitudes of elements in the input data are clustered near a high region of magnitude distribution;
an indication of whether magnitudes of elements in the input data are clustered near a low region of magnitude distribution; or
an indication of a ratio between a count of bits of elements in the input data having a value of one and a count of bits of elements in the input data having a value of zero.

15. The method of claim 14, wherein the task is assigned to one of the first accelerator, the second accelerator, and the third accelerator further based on availability of the first accelerator, the second accelerator, and the third accelerator.

16. The method of claim 15, wherein the characteristics further include an indication of similarity between the input data and corresponding input data of a respective task performed in each of the first accelerator, the second accelerator, and the third accelerator.

17. The method of claim 15, further comprising:
identifying, by the apparatus, a parameter to adjust the input data for performance of the task using one of the first accelerator, the second accelerator, and the third accelerator.

18. A non-transitory computer storage medium storing instructions which, when executed in a computing apparatus, cause the computing apparatus to perform a method, comprising:
performing, using a first accelerator of a first type, first operations of multiplication and accumulation;
performing, using a second accelerator of a second type, second operations of multiplication and accumulation;
receiving, in a memory of the computing apparatus, input data of a task of multiplication and accumulation;
receiving a request to perform the task;
analyzing the input data to determine characteristics of the input data; and
assigning the task to one of the first accelerator and the second accelerator based on the characteristics.

19. The non-transitory computer storage medium of claim 18, wherein the method further comprises:
performing, using a third accelerator of a third type, third operations of multiplication and accumulation; and
ranking energy efficiency of the first accelerator, the second accelerator, and the third accelerator based on the characteristics to assign the task to one of the first accelerator, the second accelerator, and the third accelerator;
wherein the first type, the second type, and the third type are different types from:
photonic accelerators;
analog computing modules;
digital accelerators; and
memristor accelerators.

20. The non-transitory computer storage medium of claim 18, wherein the characteristics include at least:
an indication of whether magnitudes of elements in the input data are clustered near a high region of magnitude distribution;
an indication of whether magnitudes of elements in the input data are clustered near a low region of magnitude distribution; or
an indication of a ratio between a count of bits of elements in the input data having a value of one and a count of bits of elements in the input data having a value of zero.
